(19) United States
(12) Patent Application Publication
(10) Pub. No.: US 2022/0252290 A1
(43) Pub. Date: Aug. 11, 2022

(54) IMPROVEMENTS IN OR RELATING TO CONTROL SYSTEMS FOR USE WITH HOT WORK ENCLOSURES OR HABITATS

(71) Applicant: Safehouse Habitats (Scotland) Limited, Dundee (GB)

(72) Inventor: Neil Linton, Dundee (GB)

(73) Assignee: Safehouse Habitats (Scotland) Limited, Dundee (GB)

(21) Appl. No.: 17/629,979

(22) PCT Filed: Jul. 24, 2020
(86) PCT No.: PCT/GB2020/051792

§ 371 Date: Jan. 25, 2022

(30) Foreign Application Priority Data
Jul. 26, 2019 (GB) 1910716.8

(51) Int. Cl. F24F 11/35; F24F 11/00; B23K 37/00

(52) U.S. Cl. CPC F24F 11/35; F24F 11/0001; F24F 2110/65; F24F 2011/0005; B23K 37/006

(57) ABSTRACT

A control system for use with a hot work enclosure is illustrated and described herein. The control system comprises an air supply shutdown controller, at least one air supply gas detector, and an air supply shutdown module. The air supply shutdown controller is configured to receive an air supply gas detection signal from the at least one air supply gas detector in response to the presence of gas in air to be provided to the enclosure by an air supply system. The air supply shutdown controller is configured to be responsive to the air supply gas detection signal to provide an air supply shutdown signal to the air supply shutdown module to stop the supply of air to the hot work enclosure by the air supply system. The air supply shutdown module is beatable at a first position in the air supply system, and the at least one air supply gas detector is beatable at a second position in the air supply system, such that, in use, the gas-contaminated air detected by the at least one gas detector is prevented from passing through the air supply shutdown module.

### FIELD OF THE INVENTION

The present invention relates particularly, but not exclusively, to a control system for use with a hot work enclosure. The present invention also relates to a hot work enclosure.

### BACKGROUND TO THE INVENTION

Hot work enclosures, or habitats, are often used in hazardous environments to protect workers from the ingress of flammable, noxious and combustible gases during hot work, such as welding. For example, hot work enclosures are widely used in the oil and gas industry to mitigate the risk of igniting gas contaminated air, particularly when hot work is being undertaken.

Hot work enclosures often include an air supply system configured to provide the enclosure with a supply of air, to pressurise the enclosure above atmospheric pressure, as is known in the art. However, it is thought to be difficult to control the operation of the air supply system to provide an adequate supply of air to the enclosure whilst mitigating the risk of gas contaminated air entering the enclosure.

Known hot work enclosures are also thought to suffer from a number of safety issues, and it would be desirable to make such known hot work enclosures safer, particularly, but not exclusively, when a user is undertaking hot work.

The inventors have appreciated the shortcomings in known control systems for use with a hot work enclosure, and in such known hot work enclosures.

### STATEMENTS OF INVENTION

According to a first aspect of the present invention there is provided a control system for use with a hot work enclosure, the control system comprising:
an air supply shutdown controller;

wherein the air supply shutdown controller is configured to receive an air supply gas detection signal from at least one air supply gas detector in response to the presence of gas in air to be provided to the enclosure by an air supply system;

wherein the air supply shutdown controller is configured to be responsive to the air supply gas detection signal to provide an air supply shutdown signal to an air supply shutdown module to stop the supply of air to the hot work enclosure by the air supply system; and

wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module.

It should be understood that the term “gas” means combustible gas(es), noxious gas(es) and/or non-atmospheric gas(es). It should also be understood that the term “gas” also includes atmospheric gases present in the supply of air to be provided to the habitat in concentrations that are above or below that of atmospheric gas (e.g. a higher concentration of oxygen).

The air may be atmospheric air, or air that has substantially the same properties as atmospheric air. The air may be breathable air.

It should be understood that “hot work” includes work, such as welding, that could result in the generation of sparks, or other sources of ignition, although it will be appreciated that other forms of hot work could be carried out within the hot work enclosure. It should be understood that the term “hot work enclosure” includes habitats, environments, shelters, pressurised rooms, temporary pressurised rooms, pressurised habitats, temporary pressurised habitats, pressurised environments, temporary pressurised environments, and any other form of suitable enclosure, which can be pressurised to mitigate the ingress of gas when hot work is to be undertaken, although it will be appreciated that other forms of hazardous work may be undertaken. Similarly, the hot work enclosure could be used to protect workers from other types of hazardous environment.

The first position and the second position may be arranged such that, when gas is detected in the air supply by the at least one air supply gas detector, the air supply shutdown module is operable to prevent gas-contaminated air from passing through the air supply shutdown module. The first position and the second position may be arranged such that, when gas is detected in the air supply by the at least one air supply gas detector, the air supply shutdown module is operable to shut down the supply of air to the hot work enclosure. In this arrangement, the gas-contaminated air is essentially prevented from reaching the hot work enclosure. The arrangement of the first position and the second position may be configured to suit the operating parameters of the at least one air supply gas detector and the air supply shutdown module, and the control system (e.g. the air flow rate, the volume of the air supply system, the response time of the parts of the control system including the at least one air supply gas detector and the air supply shutdown module).

The first position and/or the second position may be located at one or more regions of the air supply system.

The first position may be at an air supply shutdown region of the air supply system. The first position may be at a predetermined air supply shutdown region of the air supply system. The second position may be at an air supply gas detection region of the air supply system. The second position may be at a predetermined air supply gas detection region of the air supply system. The first position may be at an air supply shutdown region of the air supply system and the second position may be at an air supply gas detection region of the air supply system.

The first position may be substantially adjacent to the hot work enclosure. The first position may be substantially adjacent to an air inlet of the hot work enclosure.

The first position may be substantially adjacent to an end section, or end portion, of at least one air-flow component of the air supply system. The at least one air-flow component may be a conduit, duct, or channel, or the like. The air supply system may comprise one or more air-flow components. Each air-flow component may be linked in series to form an air supply path. The at least one air supply gas detector may be movable within the air supply system. The at least one air supply gas detector may be movable within the, or each, air-flow component of the air supply system. The air supply shutdown module may be movable within the air supply system. The air supply shutdown module may be movable within the, or each, air-flow component of the air supply system.

The at least one air supply gas detector may be detachably mountable within the air supply system. The at least one air supply gas detector may be detachably mountable within the, or each, air-flow component of the air supply system. The air supply shutdown module may be detachably mountable within the air supply system. The air supply shutdown module may be detachably mountable within the, or each, air-flow component of the air supply system. The at least one air supply gas detector and/or the air supply shutdown module may be detachably mountable within the air supply system.

The second position may be remote from the hot work enclosure. The second position may be remote from an air inlet of the hot work enclosure.

The first position may be between an air inlet of the air supply system and an air outlet of the air supply system. The second position may be between an air inlet of the air supply system and an air outlet of the air supply system. The first position and the second position may be between an air inlet of the air supply system and an air outlet of the air supply system. The air inlet may be an atmospheric air inlet.

The first position and the second position may be separated by a distance determined, at least in part, by the volumetric flow rate of air in the air supply system. In this arrangement, the distance between the first position and the second position is greater than or equal to the distance travelled by air in the air supply system for a given volumetric flow rate, expressed in cubic metres per second (m³/s). It will be appreciated that the operating parameters of the control system (e.g. the response time of the components including the at least one air supply gas detector and the air supply shutdown module), will have a bearing on the required minimum distance between the first position and the second position.

The first position and the second position may be arranged to be spaced apart by at least one air-flow component. The first position and the second position may be arranged to be spaced apart by a plurality of air-flow components.

The second position may be proximal to an air inlet of the air supply system. The first position may be distal to an air inlet of the air supply system. An air inlet of the air supply system may be proximal to the second position and distal to the first position.

The first position may be proximal to the hot work enclosure. The second position may be distal to the hot work enclosure. The hot work enclosure may be arranged to be proximal to the first position and distal to the second position. An air inlet of the hot work enclosure may be arranged to be proximal to the first position and distal to the second position.

The second position may be at a predetermined air supply gas detection region of the air supply system, and the first position may be at substantially the furthest possible distance from the second position within the air supply system.

The air supply shutdown module may be locatable at a predetermined air supply shutdown region of the air supply system, and the air supply shutdown module may be locatable at substantially the furthest possible distance from the at least one air supply gas detector.

The air supply shutdown controller may be arranged to receive an air supply gas detection signal from a plurality of air supply gas detectors. The air supply shutdown controller may be arranged to receive an air supply gas detection signal from only one air supply gas detector. The control system may be configured to receive the air supply gas detection signal from the, or each, air supply gas detector and the control system may be configured to provide a corresponding signal to the air supply shutdown controller. In this arrangement, the air supply gas detection signal is sent from the air supply gas detector to the air supply shutdown controller via the control system.

The, or each, air supply gas detector may be a separate component, or module, of the control system. The, or each, air supply gas detector may be a separate component, or module, from the air supply shutdown controller. The, or each, air supply gas detector may be a discrete component part of the control system.

The, or each, air supply gas detector may be movable relative to the air supply system and/or the hot work enclosure.

The, or each, air supply gas detector may be locatable at one or more positions in the air supply system. The, or each, air supply gas detector may be locatable at one or more positions in the air flow path of the air supply system. The, or each, air supply gas detector may be locatable at least partially within the air supply system. The, or each, air supply gas detector may be locatable between two or more air-flow components of the air supply system. The air-flow components may be air-flow conduits, ducts, channels, or the like.

The, or each, air supply gas detector may be connectable to the air supply system. The, or each, air supply gas detector may be connectable to one or more air-flow components of the air supply system. The, or each, air supply gas detector may be connectable between two or more air-flow components of the air supply system. The, or each, air supply gas detector may be removably attachable to the air supply system. The, or each, air supply gas detector may be removably attachable to one or more air-flow components of the air supply system. The, or each, air supply gas detector may be removably attachable between two or more air-flow components of the air supply system.

The, or each, air supply gas detector may be locatable in one or more corresponding detector receiving portions of the air supply system. The, or each, air supply gas detector may be locatable in a corresponding detector receiving portion of one or more air-flow components of the air supply system. The detector receiving portion may be one or more apertures, holes, orifices, or the like, in the air supply system. The, or each, air supply gas detector may be connectable to one or more corresponding detector receiving portions. The detector receiving portion may be located at a wall portion of an air-flow component of the air supply system. The, or each, air supply gas detector may be releasably engageable with the detector receiving portion.

The, or each, air supply gas detector may be configured to detect the presence of one or more gases in the air supply system. The, or each, air supply gas detector may be configured to detect the presence of one or more combustible, noxious, atmospheric and/or non-atmospheric gases in the air supply system. The, or each, air supply gas detector may be configured to detect the presence of one or more atmospheric gases in the air supply system. The, or each, air supply gas detector may be configured to detect the concentration of one or more gases present in the air supply system. The, or each, air supply gas detector may be configured to detect the concentration of one or more combustible, noxious, atmospheric and/or non-atmospheric gases in the air supply system. The, or each, air supply gas detector may be configured to detect the presence of one or more one or more combustible, noxious, atmospheric and/or non-atmospheric gases in the air supply system, and to provide an air supply gas detection signal to the air supply shutdown controller if the concentration of at least one of the detected gas(es) is above or below a predetermined concentration. The, or each, air supply gas detector may be configured to detect the presence and/or the concentration of hydrogen sulphide, oxygen, sulphur dioxide, and/or methane in the air supply system. Each air supply gas detector may be configured to detect at least one unique gas that is not detectable by the, or each, other air supply gas detector.

The air supply system may include one or more air inlets and one or more air outlets. The, or each, air outlet may be configured to engage with one or more corresponding air inlets of the hot work enclosure. The, or each, air inlet of the air supply system may be arranged to receive air from a source of air. The, or each, air inlet of the air supply system may be arranged to receive air from the atmosphere.

The air supply system may comprise one or more air supply devices. The control system may be operable to control the flow rate of air in the air supply system. The control system may be operable to control the, or each, air supply device. The control system may be operable to control the flow rate of air in the air supply system by controlling the operation of the, or each air supply device. The air supply device may comprise one or more fans, and/or blowers, or the like. The air supply device may be locatable at an end position, or end region, of the air supply system. The air supply device may be operable to control the flow of air through the air supply system. The, or each, air inlet of the air supply system may include an air supply device. The air supply device may be located substantially adjacent to an air inlet of the air supply system.

At least a part of the air supply system may be locatable substantially inside the hot work enclosure. At least a part of one or more air-flow components of the air supply system may be located inside the hot work enclosure.

The air supply system may be configurable to provide an air flow path from the air inlet of the air supply system, through the air supply device, through the air supply shutdown module and to the hot work enclosure.

The, or each, air supply gas detector may be locatable between at least one air inlet of the air supply system and the air supply shutdown module. The, or each, air supply gas detector may be locatable between the at least one air supply device of the air supply system and the air supply shutdown module.

The air supply shutdown module may be located remotely from the, or each, air supply gas detector, such that the first and second positions are remote from each other. The air supply shutdown module and the, or each, air supply gas detector may be arranged to be separated from each other by one or more air-flow components of the air supply system.

The air supply shutdown module and the, or each, air supply gas detector may be locatable at separate regions of the air supply system. The air supply shutdown module and the, or each, air supply gas detector may be locatable at a plurality of different regions of the air supply system.

The, or each, air supply gas detector may be independently movable relative to the air supply shutdown module. In this arrangement, the, or each, air supply gas detector can be located at a position in the air supply system that is independent of the location of the air supply shutdown module.

The, or each, air supply gas detector may be independently movable relative to the, or each, air-flow component of the air supply system. In this arrangement, the, or each, air supply gas detector can be located at a position in the air supply system that is independent of the location of the, or each, air-flow component of the air supply system.

The, or each, air supply shutdown module may be independently movable relative to the, or each, air supply gas detector. In this arrangement, the air supply shutdown module can be located at a position in the air supply system that is independent of the location of the, or each, air supply gas detector.

The, or each, air supply shutdown module may be independently movable relative to the, or each, air-flow component of the air supply system. In this arrangement, the air supply shutdown module can be located at a position in the air supply system that is independent of the location of the, or each, air-flow component of the air supply system.

The, or each, air supply gas detector may be independently movable relative to the air supply shutdown module and/or the air supply shutdown module may be independently movable relative to the, or each, air supply gas detector.

The relative position of the air supply shutdown module and the, or each, air supply gas detector may be adjustable. The relative position of the air supply shutdown module and the, or each, air-flow component of the air supply system may be adjustable. The relative position of the, or each, air supply gas detector and the, or each, air-flow component of the air supply system may be adjustable.

The air supply shutdown module and/or the, or each, air supply gas detector may be movable to a plurality of positions in the air supply system.

The, or each, air supply device may be locatable downstream of the air inlet of the air supply system. The, or each, air supply device may be locatable upstream of the air inlet of the air supply system. The, or each, air supply device may be locatable upstream of the at least one air supply gas detector. The, or each, air supply device may be locatable upstream of the at least one air supply gas detector. The, or each, air supply device may be locatable upstream of the air supply shutdown module. The, or each, air supply device may be locatable upstream of an air outlet of the air supply system. The, or each, air supply device may be locatable upstream of an air inlet of the hot work enclosure.

The at least one air supply gas detector may be locatable downstream of an air inlet of the air supply system. The at least one air supply gas detector may be locatable downstream of the, or each, air supply device. The at least one air supply gas detector may be locatable upstream of the air supply shutdown module. The at least one air supply gas detector may be locatable upstream of an air outlet of the air supply system. The at least one air supply gas detector may be locatable upstream of an air inlet of the hot work enclosure.

The air supply shutdown module may be locatable downstream of an air inlet of the air supply system. The air supply shutdown module may be locatable downstream of the, or each, air supply device. The air supply shutdown module may be locatable downstream of the at least one air supply gas detector. The air supply shutdown module may be locatable upstream of an air outlet of the air supply system. The air supply shutdown module may be locatable downstream of an air outlet of the air supply system. The air supply shutdown module may be locatable upstream of an air inlet of the hot work enclosure.

The air supply device may be located downstream of an air inlet of the air supply system, the at least one air supply gas detector may be located downstream of the air supply device, the air supply shutdown module may be located downstream of the at least one air supply gas detector and the air supply shutdown module may be located upstream of the air outlet of the air supply system, relative to the air flow path of the air supply system.

The air supply shutdown module may be a separate component, or separate module, of the control system. The air supply shutdown module may be a separate component, or separate module, from the at least one air supply gas detector. The air supply shutdown module may be a discrete component part of the control system.

The air supply shutdown module may be locatable at one or more positions in the air supply system. The air supply shutdown module may be locatable between two or more air-flow components of the air supply system. The air-flow components may be air-flow conduits, ducts, and/or channels, or the like.

The air supply shutdown module may be locatable at a position in the air supply system between the hot work enclosure and the, or each, air supply gas detector. The air supply shutdown module may be locatable at an end region, or end section, of the air supply system. The air supply shutdown module may be locatable at an end portion of an air-flow component of the air supply system. The air supply shutdown module may be locatable at an air outlet of the air supply system. The air supply shutdown module may be locatable substantially adjacent to an air outlet of the air supply system. The air supply shutdown module may be locatable remotely from an air inlet of the air supply system.

The air supply shutdown module may be connectable to the air supply system. The air supply shutdown module may be removably attachable to the air supply system. The air supply shutdown module may be connectable to one or more air-flow components of the air supply system. The air supply shutdown module may be removably attachable to one or more air-flow components of the air supply system. The air supply shutdown module may be connectable between two or more air-flow components of the air supply system. The air supply shutdown module may be removably attachable between two or more air-flow components of the air supply system.

The air supply shutdown module may be locatable in one or more corresponding shutdown module receiving portions of the air supply system. The air supply shutdown module may be locatable in a corresponding shutdown module receiving portion of one or more air-flow components of the air supply system. The shutdown module receiving portion may be one or more apertures, holes, orifices, or the like, in the air supply system. The air supply shutdown module may be connectable to one or more corresponding shutdown module receiving portions.

The, or each, air supply gas detector and the air supply shutdown module may be discrete components or discrete modules.

The air supply shutdown module may include one or more valves, damper members, dampers, barrier members, and/or flaps, or the like. The air supply shutdown module may be operable to restrict or prevent the flow of air through the air supply shutdown module.

The air supply shutdown controller may be operable to stop the supply of air to the hot work enclosure. The air supply shutdown controller may be operable to stop the supply of air to the hot work enclosure when the air supply shutdown controller receives an air supply gas detection signal from the at least one air supply gas detector. The air supply shutdown controller may be operable to stop the supply of air to the, or each, air outlet of the air supply system. The air supply shutdown controller may be operable to stop the supply of air to the, or each, air outlet of the air supply system when the air supply shutdown controller receives an air supply gas detection signal from the at least one air supply gas detector.

The air supply shutdown controller may be operable to configure the air supply shutdown module between an open state, in which air can flow through the air supply shutdown module, and a closed state, in which air is prevented from flowing through the air supply shutdown module. The air supply shutdown controller may be operable to configure the air supply shutdown module from the open state to the closed state when the air supply gas detection signal is received by the air supply shutdown controller from the at least one air supply gas detector. The air supply shutdown controller may be operable to configure the air supply shutdown module to be in the closed state when the air supply gas detection signal is received by the air supply shutdown controller from the at least one air supply gas detector. The air supply shutdown controller may be operable to configure the air supply shutdown module to be in the open state when the air supply shutdown controller is not receiving an air supply gas detection signal from the at least one air supply gas detector.

The air supply shutdown module may be arranged to prevent air being provided to the hot work enclosure by the air supply system when the air supply shutdown module is configured to be in the closed state. The air supply shutdown module may be arranged to permit air to flow to the hot work enclosure through the air supply system when the air supply shutdown module is in the open state.

The control system may be an electronic control system. The air supply shutdown controller may be an electronic apparatus. The control system may be a portable apparatus. The air supply shutdown controller may be a portable apparatus. The air supply shutdown controller, the air supply shutdown module and/or the, or each, air supply gas detector may be configured to be separate, discrete components of the control system.

The control system may be operable to communicate with a further control system. The further control system may be operable to control the operation of the control system. The control system may be operable to communicate with a further control system by way of a wireless communication protocol and/or by way of a wired electrical connection.

The control system and/or the further control system may include one or more computing devices, programmable computing devices, programmable processors and/or processors. The, or each, computing device may include one or more user interfaces. The, or each, computing device may be a tablet computer, a laptop, a PC, a mobile computing device, such as a mobile or cellular telephone, or the like.

The control system and/or the further control system may be configured to receive the air supply gas detection signal from the at least one air supply gas detector and to provide a corresponding signal to the air supply shutdown controller. In this arrangement, the air supply gas detection signal is sent from the air supply gas detector to the air supply shutdown controller via the control system and/or the further control system.

The control system and the further control system may be locatable remotely from each other. In this arrangement, the control system may be locatable on an offshore location, or site, such as an offshore platform or rig, or a vessel, and the further control system may be located at an onshore site.

The hot work enclosure may be a temporary enclosure, structure, habitat, or environment. The hot work enclosure may be a permanent or fixed structure. It will be understood that the hot work enclosure may take any suitable form for providing a pressurised environment for, optionally, carrying out hot work. That is, in some situations the hot work enclosure may be used to prevent the ingress of flammable gas to an area used to carry out other forms of work.

The control system may be operable to control the supply of air to the hot work enclosure from the air supply system. The control system may be operable to provide a positive pressure difference between the inside of the hot work enclosure and the outside of the hot work enclosure. In this arrangement, the inside of the hot work enclosure can be maintained at a higher air pressure than that of the outside environment.

The hot work enclosure may include an air outlet arranged to allow air to exit the hot work enclosure. In this arrangement, the air supply system is operable to purge the hot work enclosure by providing air to the hot work enclosure, the air then exiting the hot work enclosure through the air outlet of the hot work enclosure.

The control system may comprise an enclosure shutdown controller. The control system may be operable to control the operation of the enclosure shutdown controller. The control system may be operable to send an enclosure shutdown signal to the enclosure shutdown controller to stop the supply of electrical power to at least one apparatus for carrying out hot work. The enclosure shutdown controller may be operable to stop the supply of electrical power to at least one apparatus for carrying out hot work. The, or each, apparatus for carrying out hot work may be located at least partially inside the hot work enclosure. The enclosure shutdown controller may be operable to stop the supply of electrical power to all of the apparatus for carrying out hot work.

The enclosure shutdown controller may be operable to stop the supply of electrical power to the at least one apparatus for carrying out hot work when the air supply shutdown controller receives an air supply gas detection signal from the at least one air supply gas detector in response to the presence of gas in air to be provided to the enclosure by the air supply system.

The control system may be operable to receive an enclosure gas detection signal from at least one enclosure gas detector in response to the presence of gas in the enclosure. At least a part of the, or each, enclosure gas detector may be locatable inside the hot work enclosure. The enclosure shutdown controller may be operable to stop the supply of electrical power to the at least one apparatus for carrying out hot work when the control system receives the enclosure gas detection signal.

The control system may be operable to receive an external gas detection signal from at least one external gas detector in response to the presence of gas outside of the hot work enclosure and/or the air supply system. At least a part of the, or each, external gas detector may be locatable outside the hot work enclosure and/or the air supply system. The enclosure shutdown controller may be operable to stop the supply of electrical power to the at least one apparatus for carrying out hot work when the control system receives the external gas detection signal.

The control system may be operable to maintain the supply of air to the hot work enclosure when the control system receives an external gas detection signal. The control system may be operable to maintain the supply of air to the hot work enclosure when the control system receives an enclosure gas detection signal.

The control system may be operable to stop the supply of electrical power to the at least one apparatus for carrying out hot work when the control system receives a gas detection signal from at least one of: the at least one air supply gas detector, the at least one external gas detector, and the at least one enclosure gas detector.

The enclosure shutdown controller may be operable to provide an enclosure shutdown signal to an enclosure shutdown module to stop the supply of electrical power to the one or more apparatuses for carrying out hot work. The enclosure shutdown module may include one or more magnetic switches, relays, and/or solenoids, or the like.

The control system may be operable to communicate with one or more alarm devices. The alarm devices may be located inside the hot work enclosure, outside the hot work enclosure, and/or adjacent the air supply system. At least one of the alarm devices may be located inside the hot work enclosure and at least one of the alarm devices may be located outside the hot work enclosure. The one or more alarm devices may be operable to provide an alarm signal to a user of the hot work enclosure in the event of one or more alarm conditions. An alarm condition may be triggered by the control system receiving one or more gas detection signals.

The control system may be operable to control one or more light emitting elements located inside and/or outside the hot work enclosure. The light emitting element may be a light emitting diode, or the like. At least one of the light emitting elements may be configured to function as an alarm device.

The control system may be configured to indicate the status of the one or more apparatuses for carrying out hot work. That is, at least, whether the apparatus for carrying out hot work can be supplied with electrical power. The control system may be configured to indicate the status of the one or more apparatuses for carrying out hot work and to prompt the user of the control system to activate the one or more apparatuses for carrying out hot work. The control system may comprise one or more indicator elements configured to indicate the status of the apparatus for carrying out hot work. The one or more indicator elements may include one or more light emitting elements. The light emitting elements may be light emitting diodes, or the like.

The control system may be operable to activate a back-up power supply in the event of loss of power to the control system. The back-up power supply may include one or more batteries, or the like.

The control system may be operable to receive an entrance signal from one or more entrance points of the hot work enclosure when the, or each, entrance point is configured in an open state. The enclosure shutdown controller may be operable to stop the supply of electrical power to the one or more apparatuses for carrying out hot work when the control system receives the entrance signal. The control system may be operable to apply a time-delay between receiving the entrance signal and stopping the supply of electrical power to the at least one apparatus for carrying out hot work. The time-delay may be between approximately 1 second and approximately 60 seconds. The time-delay may be between approximately 5 seconds and approximately 20 seconds. The time-delay may be between approximately 8 seconds and approximately 12 seconds. The time-delay may be approximately 10 seconds.

The control system may be operable to purge the hot work enclosure when the control system detects that the entrance point has been in the open state for a period of time. The period of time may be between approximately 1 second and approximately 120 seconds. The period of time may be between approximately 30 seconds and approximately 90 seconds. The period of time may be between approximately 50 seconds and approximately 70 seconds. The period of time may be between approximately 55 seconds and approximately 65 seconds. The period of time may be approximately 60 seconds.

The control system may be operable to detect when the, or each, entrance point to the hot work enclosure is in a closed state. The control system may be operable to receive a unique code, or signal, from the, or each, entrance point when the, or each, entrance point is in the closed state. The unique code, or signal, may be provided from a magnetic lock, a magnetic switch, or the like. The enclosure shutdown controller may be operable to stop the supply of electrical power to the one or more apparatuses for carrying out hot work if the control system detects that an entrance point to the hot work enclosure is not in the closed state.

The control system may be configured to receive electrical power from an electrical power supply. The control system may be configured to receive electrical power from a single phase power supply. The, or each, air supply device may be configured to receive electrical power from an electrical power supply. The, or each, air supply device may be configured to receive electrical power from a single phase power supply.

The control device may be configured to receive electrical power from a first power supply. The, or each, air supply device may be configured to receive electrical power from a second power supply. The first and second power sources may be separate electrical power supplies. The first power supply and/or the second power supply may be a single phase power supply.

The at least one apparatus for carrying out hot work may be configured to receive electrical power from a single phase power supply. The single phase power supply may be provided from a power supply module. The power supply module may comprise a three phase electrical input and a single phase electrical output.

The control system may be operable to detect the air flow rate of the air provided to the hot work enclosure. The control system may be operable to receive an air flow rate signal from one or more air flow rate sensors. The, or each, air flow rate sensor may be locatable in the air supply system and/or locatable inside the hot work enclosure. The control system may be operable to calculate the time required to purge the hot work enclosure based, at least in part, on the air flow rate signal. It should be understood that the time required to purge the hot work enclosure will be approximately equivalent to the time required to render the hot work enclosure safe to enter by a user of the hot work enclosure.

The control system may be operable to obtain image and/or video data from one or more image capture devices. The one or more image capture devices may be locatable inside and/or outside the hot work enclosure.

The control system may be operable to obtain data from one or more sensors. The sensors may be locatable inside and/or outside the hot work enclosure. The sensors may be configured to measure temperature, air pressure, humidity, dew point, particulate matter, and/or dust.

The control system may be configured to display data obtained, or associated with, the at least one air supply gas detector, the at least one external gas detector, the at least one enclosure gas detector, the one or more sensors, the one or more image capture devices, and/or the one or more air flow rate sensors. The control system may be configured to display real time data obtained, or associated with, the at least one air supply gas detector, the at least one external gas detector, the at least one enclosure gas detector, the one or more sensors, the one or more image capture devices, and/or the one or more air flow rate sensors.

The further control system may be configured to display real time data obtained from the control system. The control system may be configured to display real time date obtained from the further control system.

The control system may be operable to obtain input data from a user and to activate the air supply shutdown controller to provide the air supply shutdown signal to the air supply shutdown module. The control system may be operable to obtain input data from a user and to activate the enclosure shutdown controller to stop the supply of electrical power to the at least one apparatus for carrying out hot work. The control system may comprise a user input device for obtaining input data from the user. The user input device may be a touch-screen interface, or the like, and/or one or more buttons, or the like.

The control system may be operable to obtain data from the at least one enclosure gas detector using a wireless communication protocol. The control system may be operable to obtain data from the at least one external gas detector using a wireless communication protocol. The control system may be operable to obtain data from the at least one air supply gas detector using a wireless communication protocol. The control system may be operable to communicate with the one or more sensors, the one or more image capture devices, the air supply shutdown module and/or the one or more air flow rate sensors using a wireless communication protocol and/or a wired connection. The control system may be operable to control the air supply shutdown module using a wireless communication protocol.

The control system may be operable to obtain data from the at least one enclosure gas detector using a wired communication channel. The control system may be operable to obtain data from the at least one external gas detector using a wired communication channel. The control system may be operable to obtain data from the at least one air supply gas detector using a wired communication channel. The control system may be operable to communicate with the one or more sensors, the one or more image capture devices, the air supply shutdown module and/or the one or more air flow rate sensors using a wireless communication protocol and/or a wired connection. The control system may be operable to control the air supply shutdown module using a wired communication protocol.

According to a second aspect of the present invention there is provided a control system for use with a hot work enclosure, the control system comprising:
an air supply shutdown controller;
at least one air supply gas detector; and
an air supply shutdown module;

wherein the air supply shutdown controller is configured to receive an air supply gas detection signal from the at least one air supply gas detector in response to the presence of gas in air to be provided to the enclosure by an air supply system;

wherein the air supply shutdown controller is configured to be responsive to the air supply gas detection signal to provide an air supply shutdown signal to the air supply shutdown module to stop the supply of air to the hot work enclosure by the air supply system; and

wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module.

The control system may comprise the air supply system. The air supply system may comprise an air supply device. The control system may comprise the hot work enclosure. The air supply system may comprise one or more air-flow components. The control system may comprise one or more connector devices configured to connect the one or more air flow components together.

Embodiments of the second aspect of the present invention may include one or more features of the first aspect of the present invention or its embodiments. Similarly, embodiments of the first aspect of the present invention may include one or more features of the second aspect of the present invention or its embodiments.

According to a third aspect of the present invention there is provided a hot work enclosure comprising a control system for use with a hot work enclosure, the control system comprising:
an air supply shutdown controller;

wherein the air supply shutdown controller is configured to receive an air supply gas detection signal from at least one air supply gas detector in response to the presence of gas in air to be provided to the enclosure by an air supply system;

wherein the air supply shutdown controller is configured to be responsive to the air supply gas detection signal to provide an air supply shutdown signal to an air supply shutdown module to stop the supply of air to the hot work enclosure by the air supply system; and

wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module.

The hot work enclosure may comprise one or more air inlets. The, or each, air inlet of the hot work enclosure may be engageable with one or more air outlets of the air supply system.

Embodiments of the third aspect of the present invention may include one or more features of the first and/or second aspects of the present invention or their embodiments. Similarly, embodiments of the first and/or second aspects of the present invention may include one or more features of the third aspect of the present invention or its embodiments.

According to a fourth aspect of the present invention there is provided a hot work enclosure comprising a control system for use with a hot work enclosure, the control system comprising:
an air supply shutdown controller;
at least one air supply gas detector; and
an air supply shutdown module;

wherein the air supply shutdown controller is configured to receive an air supply gas detection signal from the at least one air supply gas detector in response to the presence of gas in air to be provided to the enclosure by an air supply system;

wherein the air supply shutdown controller is configured to be responsive to the air supply gas detection signal to provide an air supply shutdown signal to the air supply shutdown module to stop the supply of air to the hot work enclosure by the air supply system; and

wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module.

Embodiments of the fourth aspect of the present invention may include one or more features of the first, second and/or third aspects of the present invention or their embodiments. Similarly, embodiments of the first, second, and/or third aspects of the present invention may include one or more features of the fourth aspect of the present invention or its embodiments.

According to a fifth aspect of the present invention there is provided a control system for use with a hot work enclosure, the control system comprising:
an air supply shutdown controller;

wherein the air supply shutdown controller is configured to receive an air supply gas detection signal from at least one air supply gas detector in response to the presence of gas in air to be provided to the enclosure by an air supply system; and

wherein the air supply shutdown controller is configured to be responsive to the air supply gas detection signal to provide an air supply shutdown signal to an air supply shutdown module to stop the supply of air to the hot work enclosure by the air supply system.

Embodiments of the fifth aspect of the present invention may include one or more features of the first, second, third and/or fourth aspects of the present invention or their embodiments. Similarly, embodiments of the first, second, third and/or fourth aspects of the present invention may include one or more features of the fifth aspect of the present invention or its embodiments.

According to a sixth aspect of the present invention there is provided a hot work enclosure, the hot work enclosure comprising a control system for use with a hot work enclosure, the control system comprising:
an air supply shutdown controller;

wherein the air supply shutdown controller is configured to receive an air supply gas detection signal from at least one air supply gas detector in response to the presence of gas in air to be provided to the enclosure by an air supply system; and

wherein the air supply shutdown controller is configured to be responsive to the air supply gas detection signal to provide an air supply shutdown signal to an air supply shutdown module to stop the supply of air to the hot work enclosure by the air supply system.

Embodiments of the sixth aspect of the present invention may include one or more features of the first, second, third, fourth and/or fifth aspects of the present invention or their embodiments. Similarly, embodiments of the first, second, third, fourth and/or fifth aspects of the present invention may include one or more features of the sixth aspect of the present invention or its embodiments.

According to a seventh aspect of the present invention there is provided a method of controlling the supply of air to a hot work enclosure, the method comprising the steps of:
providing a control system for use with a hot work enclosure, the control system comprising:
an air supply shutdown controller;

wherein the air supply shutdown controller is arranged to receive an air supply gas detection signal from at least one air supply gas detector in response to the presence of gas in air to be provided to the enclosure by an air supply system;

wherein the air supply shutdown controller is configured to be responsive to the air supply gas detection signal to provide an air supply shutdown signal to an air supply shutdown module to stop the supply of air to the hot work enclosure by the air supply system;

wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module; and using the control system to control the supply of air to the hot work enclosure.

Embodiments of the seventh aspect of the present invention may include one or more features of the first, second, third, fourth, fifth and/or sixth aspects of the present invention or their embodiments. Similarly, embodiments of the first, second, third, fourth, fifth and/or sixth aspects of the present invention may include one or more features of the seventh aspect of the present invention or its embodiments.

According to an eighth aspect of the present invention there is provided a method of controlling the supply of air to a hot work enclosure, the method comprising the steps of:

providing a control system for use with a hot work enclosure, the control system comprising:
an air supply shutdown controller;
at least one air supply gas detector; and
an air supply shutdown module;

wherein the air supply shutdown controller is configured to receive an air supply gas detection signal from the at least one air supply gas detector in response to the presence of gas in air to be provided to the enclosure by an air supply system;

wherein the air supply shutdown controller is configured to be responsive to the air supply gas detection signal to provide an air supply shutdown signal to the air supply shutdown module to stop the supply of air to the hot work enclosure by the air supply system; and

wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module; and using the control system to control the supply of air to the hot work enclosure.

Embodiments of the eighth aspect of the present invention may include one or more features of the first, second, third, fourth, fifth, sixth and/or seventh aspects of the present invention or their embodiments. Similarly, embodiments of the first, second, third, fourth, fifth, sixth and/or seventh aspects of the present invention may include one or more features of the eighth aspect of the present invention or its embodiments.

According to a ninth aspect of the present invention there is provided a method of controlling the operation of a hot work enclosure, the method comprising the steps of:
providing a hot work enclosure comprising a control system for use with a hot work enclosure, the control system comprising:
   an air supply shutdown controller;
wherein the air supply shutdown controller is configured to receive an air supply gas detection signal from at least one air supply gas detector in response to the presence of gas in air to be provided to the enclosure by an air supply system;
wherein the air supply shutdown controller is configured to be responsive to the air supply gas detection signal to provide an air supply shutdown signal to an air supply shutdown module to stop the supply of air to the hot work enclosure by the air supply system; and
wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module; and

controlling the supply of air to the hot work enclosure using the control system.

Embodiments of the ninth aspect of the present invention may include one or more features of the first, second, third, fourth, fifth, sixth, seventh, and/or eighth aspects of the present invention or their embodiments. Similarly, embodiments of the first, second, third, fourth, fifth, sixth, seventh and/or eighth aspects of the present invention may include one or more features of the ninth aspect of the present invention or its embodiments.

According to a tenth aspect of the present invention, there is provided a method of controlling the operation of a hot work enclosure, the method comprising the steps of:
providing a hot work enclosure comprising a control system for use with a hot work enclosure, the control system comprising:
   an air supply shutdown controller;
   at least one air supply gas detector; and
   an air supply shutdown module;
wherein the air supply shutdown controller is configured to receive an air supply gas detection signal from the at least one air supply gas detector in response to the presence of gas in air to be provided to the enclosure by an air supply system;
wherein the air supply shutdown controller is configured to be responsive to the air supply gas detection signal to provide an air supply shutdown signal to the air supply shutdown module to stop the supply of air to the hot work enclosure by the air supply system; and
wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module; and

controlling the supply of air to the hot work enclosure using the control system.

Embodiments of the tenth aspect of the present invention may include one or more features of the first, second, third, fourth, fifth, sixth, seventh, eighth and/or ninth aspects of the present invention or their embodiments. Similarly, embodiments of the first, second, third, fourth, fifth, sixth, seventh, eighth and/or ninth aspects of the present invention may include one or more features of the tenth aspect of the present invention or its embodiments.

According to an eleventh aspect of the present invention there is provided a method of controlling the supply of air to a hot work enclosure, the method comprising the steps of:
providing a control system for use with a hot work enclosure, the control system comprising:
an air supply shutdown controller;

wherein the air supply shutdown controller is configured to receive an air supply gas detection signal from at least one air supply gas detector in response to the presence of gas in air to be provided to the enclosure by an air supply system; and

wherein the air supply shutdown controller is configured to be responsive to the air supply gas detection signal to provide an air supply shutdown signal to an air supply shutdown module to stop the supply of air to the hot work enclosure by the air supply system; and

controlling the supply of air to the hot work enclosure using the control system.

Embodiments of the eleventh aspect of the present invention may include one or more features of the first, second, third, fourth, fifth, sixth, seventh, eighth, ninth and/or tenth aspects of the present invention or their embodiments. Similarly, embodiments of the first, second, third, fourth, fifth, sixth, seventh, eighth, ninth and/or tenth aspects of the present invention may include one or more features of the eleventh aspect of the present invention or its embodiments.

According to a twelfth aspect of the present invention there is provided a method of operating a hot work enclosure, the method comprising the steps of:
providing a hot work enclosure comprising a control system for use with a hot work enclosure, the control system comprising:
   an air supply shutdown controller;
wherein the air supply shutdown controller is configured to receive an air supply gas detection signal from at least one air supply gas detector in response to the presence of gas in air to be provided to the enclosure by an air supply system; and
wherein the air supply shutdown controller is configured to be responsive to the air supply gas detection signal to provide an air supply shutdown signal to an air supply shutdown module to stop the supply of air to the hot work enclosure by the air supply system; and

controlling the supply of air to the hot work enclosure using the control system.

Embodiments of the twelfth aspect of the present invention may include one or more features of the first, second, third, fourth, fifth, sixth, seventh, eighth, ninth, tenth and/or eleventh aspects of the present invention or their embodiments. Similarly, embodiments of the first, second, third, fourth, fifth, sixth, seventh, eighth, ninth, tenth and/or eleventh aspects of the present invention may include one or more features of the twelfth aspect of the present invention or its embodiments.

### BRIEF DESCRIPTION OF THE DRAWINGS

Embodiments of the invention will now be described, by way of example, with reference to the drawings, in which:

FIG. 1 shows a control system for use with a hot work enclosure according to an embodiment of the present invention; and

FIG. 2 is a perspective view of the control system of FIG. 1.

### DESCRIPTION OF PREFERRED EMBODIMENTS

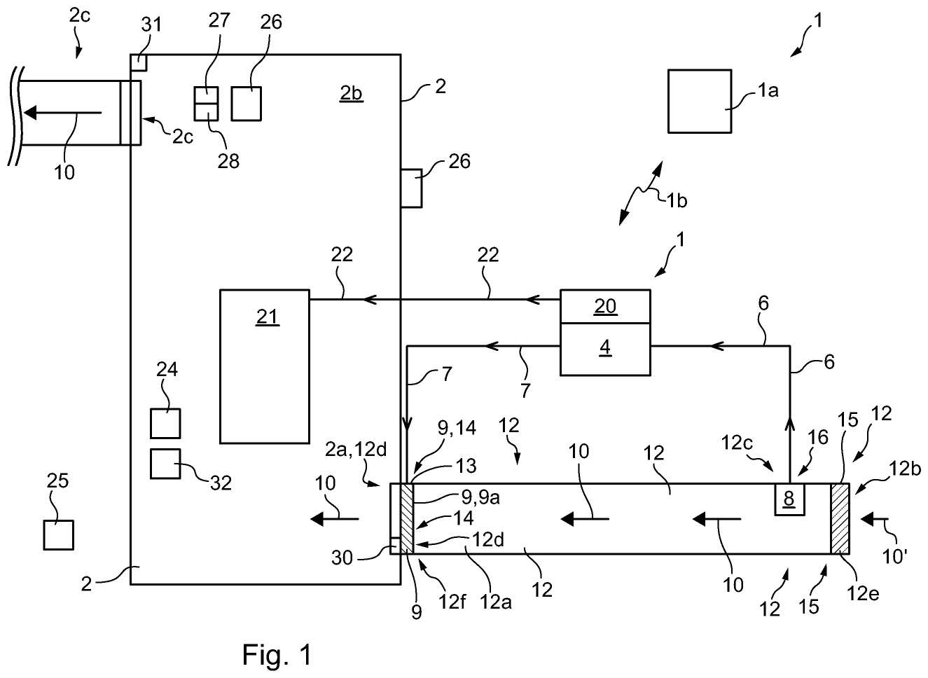

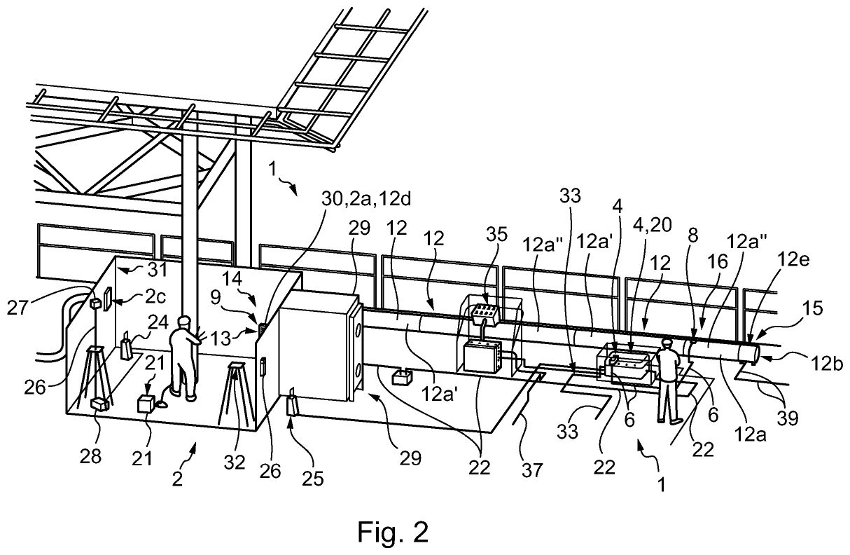

With reference to FIGS. 1 and 2, a control system 1 for use with a hot work enclosure 2 is shown.

The control system 1 includes an air supply shutdown controller 4 configured to receive an air supply gas detection signal 6 from at least one air supply gas detector 8 in response to the presence of gas in air 10 to be provided to the enclosure 2 by an air supply system 12. The air supply shutdown controller 4 is configured to be responsive to the air supply gas detection signal 6 to provide an air supply shutdown signal 7 to an air supply shutdown module 9 to stop the supply of air 10 to the hot work enclosure 2 by the air supply system 12. As shown in FIG. 1, the air supply shutdown module 9 is located at a first position 14 in the air supply system 12, and the air supply gas detector 8 is located at a second position 16 in the air supply system 12, such that, in use, the gas-contaminated air detected by the air supply gas detector 8 is prevented from passing through the air supply shutdown module 9.

The air supply system 12 includes an air inlet 12b configured to receive atmospheric air 10′ and an air outlet 12d configured to engage with a corresponding air inlet 2a of the hot work enclosure 2. The air supply system 12 also includes an air supply device 12e (a fan), which is used to control the flow rate of air 10. It will be understood that other air supply devices 12e could be used, such as blowers, or the like.

In the embodiments illustrated and described here, the air supply device 12e is locatable at an end region 15, of the air supply system 12. Thus, the volume of the air supply system 12 in which the air supply gas detector 8 and the air supply shutdown module 9 can be located is increased, as the air supply device 12e is located at the end region 15 of the air supply system 12.

In the embodiment illustrated and described here, atmospheric air 10′ is provided to the enclosure 2. It will be appreciated that a supply of air, for example breathable air or air with substantially the same properties as atmospheric air could be provided to the enclosure 2.

In the embodiments illustrated and described here, the first position 14 and the second position 16 are arranged such that, when gas is detected in the air supply 12 by the air supply gas detector 8, the air supply shutdown module 9 is operable to prevent gas-contaminated air from passing through the air supply shutdown module 9. That is, the first position 14 and the second position 16 are arranged such that, when gas is detected in the air supply 12 by the air supply gas detector 8, the air supply shutdown module 9 is operable to shut down the supply of air 10 to the hot work enclosure 2. In this arrangement, the gas-contaminated air is essentially prevented from reaching the hot work enclosure 2. The arrangement of the first position 14 and the second position 16 are typically selected to suit the operating parameters of the control system 1. For example, the operating parameters of the air supply gas detector 8 and the air supply shutdown module 9, the air flow rate, the volume of the air supply system 12, and the response time of the air supply gas detector 8 and the air supply shutdown module 9, could all be taken into account when determining the optimum arrangement of the first and second positions 14, 16.

The first position 14 is, in the embodiments illustrated and described here, at a predetermined air supply shutdown region of the air supply system 12 and the second position 16 is at a predetermined air supply gas detection region of the air supply system 12.

The first position 14 is located near to an air inlet 2a of the hot work enclosure 2, and the first position 14 is substantially adjacent to an end portion 13 of at least one air-flow component 12a of the air supply system 12. It is thought to be advantageous for the first position (and thus the air supply shutdown module 9) to be at an end portion 13 of an air flow component 12a, as this maximises the distance that gas contaminated air has to travel in order to reach the air supply shutdown module 9.

In the embodiment illustrated in FIG. 1, the air supply system 12 includes one air-flow component 12a, which is a conduit, although in other embodiments, as shown in FIG. 2, the air supply system comprises a plurality of air-flow components 12a′, 12a″, linked in series to form an air-flow path.

The at least one air supply gas detector 8 is movable within the air supply system 12 and within each air-flow component 12a, 12a′, 12a″. The air supply shutdown module 9 is movable within the air supply system 12 and within the, or each, air-flow component 12a of the air supply system 12. Therefore, the location of the at least one air supply gas detector 8 and the air supply shutdown module 9 can be adjusted depending, at least in part, on the operating parameters of the control system 1.

The at least one air supply gas detector 8 is detachably mountable within the air supply system 12 and the air supply shutdown module 9 is detachably mountable within the air supply system 12. Thus, if the location of the air supply gas detector 8 and/or the air supply shutdown module 9 need to be adjusted, perhaps quickly, this can be done in a more efficient manner.

The second position 16 is remote from the air inlet 2a of the hot work enclosure 2. Thus the location of the air supply gas detector 8 is also remote from the air inlet 2a, which provides more time for gas to be detected in the air supply system 12 and to allow for sufficient time for the air supply shutdown module 9 to be operated to stop the supply of gas contaminated air to the enclosure 2.

Typically, the first position 14 and the second position 16 are separated by a distance determined, at least in part, by the volumetric flow rate of air 10 in the air supply system 12. In this arrangement, the distance between the first position 14 and the second position 16 is greater than or equal to the distance travelled by air 10 in the air supply system 12 for a given volumetric flow rate, expressed in cubic metres per second (m³/s). It will be appreciated that the operating parameters of the control system 1 (e.g. the response time of the components including the air supply gas detector 8 and the air supply shutdown module 9), will have a bearing on the required minimum distance between the first position 14 and the second position 16. It should be appreciated that other methods of determining a suitable arrangement of the first and second positions 14, 16, and thus the position of the air supply gas detector 8 relative to the air supply shutdown module 9, are possible.

As shown in FIGS. 1 and 2, the first position 14 and the second position 16 are arranged to be spaced apart by at least one air-flow component 12a.

The second position 16, and thus the air supply gas detector 8 is proximal to the air inlet 12b of the air supply system 12 and distal to the air inlet 2a of the enclosure 2. Thus, in this arrangement, the air supply gas detector 8 can detect the presence of gas contaminated air almost as soon as it enters the air supply system 12. In the embodiments illustrated and described here, the first position 14 is proximal to the air inlet 2a of the enclosure 2 and distal to the air inlet 12b of the air supply system 12, and the air supply shutdown module 9 is located far enough away from the air supply gas detector 8 to ensure that gas contaminated air can be prevented from reaching the enclosure 2. It should be understood that other arrangements of the first and second positions 14 and 16 are possible in which the proximal/distal positioning outlined above is maintained.

In the embodiment shown in FIG. 1 the second position 16 (and thus the air supply gas detector 8) is at a predetermined air supply gas detection region of the air supply system 12, and the first position 14 (i.e. the air supply shutdown module 9) is at substantially the furthest possible distance from the second position 16 within the air supply system 12. It will be understood that the minimum required separation distance between the first and second positions 14 and 16 will vary depending on the operating parameters of the control system 1.

In the embodiments illustrated and described here, the air supply gas detector 8 and the air supply shutdown module 9 are each separate components, or separate modules, of the control system 1, and are each movable relative to the air supply system 12 and the hot work enclosure 2. This allows their positions within the air supply system 12 to be adjusted. That is, the air supply gas detector 8 and the air supply shutdown module 9 can be located at a plurality of positions in the air supply system 12 and, particularly, within the air flow path thereof.

As shown in FIG. 1, the air supply gas detector 8 is located within a single air-flow component 12a. In other embodiments the, or each, air supply gas detector 8 could be located between two or more air-flow components 12a, 12a′, 12a″ of the air supply system 12.

The air supply gas detector 8 is independently movable relative to the air supply shutdown module 9. In this arrangement, the, or each, air supply gas detector 8 can be located at a position in the air supply system 12 that is independent of the location of the air supply shutdown module 9.

The air supply gas detector 8 is also independently movable relative to the, or each, air-flow component 12a, 12a′, 12a″ of the air supply system 12. In this arrangement, the air supply gas detector 8 can be located at a position in the air supply system 12 that is independent of the location of the, or each, air-flow component 12a of the air supply system 12.

The air supply shutdown module 9 is independently movable relative to the air supply gas detector 8. In this arrangement, the air supply shutdown module 9 can be located at a position in the air supply system 12 that is independent of the location of the air supply gas detector 8.

The air supply shutdown module 9 is independently movable relative to the, or each, air-flow component 12a of the air supply system 12. In this arrangement, the air supply shutdown module 9 can be located at a position in the air supply system 12 that is independent of the location of the, or each, air-flow component 12a, 12a′, 12a″ of the air supply system 12.

Thus, the relative position of the air supply shutdown module 9 and the air supply gas detector 8 is adjustable. Furthermore, the relative position of the air supply shutdown module 9 and the, or each, air-flow component 12a of the air supply system 12 is adjustable. Moreover, the relative position of the, or each, air supply gas detector 8 and the, or each, air-flow component 12a of the air supply system 12 is adjustable.

As best shown in FIG. 2, the air supply gas detector 8 is removably attachable to a detector receiving portion 12c of an air flow component 12a of the air supply system 12. Thus, the position of the air supply gas detector 8 within the air supply system 12 can be adjusted in an efficient manner if, for example, the volumetric flow rate of the air supply system 12 is to be changed. The detector receiving portion 12c is an orifice in a wall portion of an air-supply component 12a. However, it should be understood that other detector receiving portions 12c could be used.

The air supply gas detector 8 is configured to detect the presence and the concentration of one or more combustible, noxious, non-atmospheric and/or atmospheric gases in the air supply system 12. In the embodiments illustrated and described here, the air supply gas detector 8 is configured to provide an air supply gas detection signal 6 to the air supply shutdown controller 4 if the concentration of at least one of the detected gases is above or below a predetermined concentration. The air supply gas detector 8 is configured to detect the presence and/or the concentration of hydrogen sulphide, oxygen, sulphur dioxide, and/or methane in the air supply system 12.

As shown in FIG. 1, the air supply device 12e is located downstream of the air inlet 12b of the air supply system 12, the at least one air supply gas detector 8 is located downstream of the air supply device 12e, the air supply shutdown module 9 is located downstream of the at least one air supply gas detector 8, the air supply shutdown module 9 is located upstream of the air outlet 12d of the air supply system 12 and the air inlet 2a of the hot work enclosure 2, relative to the air flow path of the air supply system 12.

The air supply shutdown module 9 is removably attachable to an air-flow component 12a of the air supply system 12, and is locatable in one or more corresponding shutdown module receiving portions 12f of the air supply system 12.

The air supply shutdown controller 4 is operable to stop the supply of air 10 to the air outlet 12d of the air supply system 12 and the air inlet 2a of the hot work enclosure 2 when the air supply shutdown controller 4 receives an air supply gas detection signal 6 from the at least one air supply gas detector 8.

The air supply shutdown controller 4 is operable to configure the air supply shutdown module 9 between an open state, in which air 10 can flow through the air supply shutdown module 9, and a closed state, in which air 10 is prevented from flowing through the air supply shutdown module 9. The air supply shutdown module 9 includes a damper member 9a operable to restrict or prevent the flow of air 10 therethrough. It will be understood that in other embodiments, the air supply shutdown module 9 could include one or more barrier members, valves, or the like.

In the embodiments illustrated and described here, the control system 1 and the air supply shutdown controller 4 are portable, electronic control apparatus. The air supply shutdown controller 4, the air supply shutdown module 9 and the, or each, air supply gas detector 8 are arranged to be separate, discrete components of the control system 1 and are each portable components. The control system 1 is thus a portable control system 1 which can be moved to new locations in an efficient manner, which is thought to be advantageous in temporary habitat, or enclosure, applications, where the habitat is often moved to a new location once work is complete. Furthermore, the layout or arrangement of the control system 1 can be determined with a greater degree of flexibility that at least some of the conventional control systems used to control the operation of hot work enclosures.

In the embodiments illustrated and described here, the control system 1 is operable to communicate with a further control system 1a via a wireless communication protocol 1b. The further control system 1a is operable to control the operation of the control system 1. In this embodiment, the further control system 1a is a tablet computer, which can be recharged by way of a wired connection to the control system 1.

Thus, the control system 1 and the further control system 1a are locatable remotely from each other and can communicate by, for example, WiFi (an example of a wireless communication protocol 1b). The control system 1 could be located on an offshore location, or site, such as an offshore platform or rig, or a vessel, and the further control system 1a could located at an onshore site.

As best shown in FIG. 2, the hot work enclosure 2 is a temporary enclosure, structure, habitat, room, or environment. It will be understood that the hot work enclosure 2 may take any suitable form for providing a pressurised environment for, optionally, carrying out hot work. That is, in some situations the hot work enclosure 2 could be used to prevent the ingress of flammable gas to an area used to carry out other forms of work.

The control system 1 is operable to control the supply of air 10 to the hot work enclosure 2 from the air supply system 12 to provide a positive pressure difference between the inside 2b and the outside of the hot work enclosure 2. In this arrangement, the inside 2b of the hot work enclosure 2 can be maintained at a higher air pressure than that of the outside environment.

As shown in FIG. 1, the hot work enclosure 2 includes an air outlet 2c arranged to allow air 10 to exit the hot work enclosure 2. In this arrangement, the air supply system 12 is operable to purge the hot work enclosure 2 by providing air 10 to the hot work enclosure 2, the air 10 then exiting the hot work enclosure 2 through the air outlet 2c of the hot work enclosure 2.

The control system 1 includes an enclosure shutdown controller 20 configured to provide an apparatus for carrying out hot work 21 (e.g. a welding apparatus) with a supply of electrical power 22. The control system 1 is operable to send an enclosure shutdown signal to the enclosure shutdown controller 20 to stop the supply of electrical power 22 to the apparatus for carrying out hot work 21 when the air supply shutdown controller 4 receives an air supply gas detection signal 6. As described in more detail below, when gas is detected in the air supply system 12, the supply of electrical power 22 to the apparatus for carrying out hot work 21 is stopped. Thus, the risk of igniting a flammable gas is mitigated, and it will be appreciated that preventing the gas contaminated air from entering the enclosure 2 and shutting down the apparatus for carrying out hot work 21 both help to mitigate the risk of igniting flammable gas.

In the embodiments illustrated and described here, the apparatus for carrying out hot work 21 is located at least partially inside the hot work enclosure 2.

As shown in FIGS. 1 and 2 the control system 1 is operable to receive an enclosure gas detection signal (using a wireless communication protocol) from at least one enclosure gas detector 24 in response to the presence of gas in the enclosure 2. In the embodiments illustrated and described here, the enclosure gas detector 24 is located inside the hot work enclosure 2. The enclosure shutdown controller 20 is operable to stop the supply of electrical power 22 to the apparatus for carrying out hot work 21 when the control system 1 receives the enclosure gas detection signal.

The control system 1 is operable to receive an external gas detection signal (using a wireless communication protocol) from an external gas detector 25 in response to the presence of gas outside of the hot work enclosure 2 and/or the air supply system 12. In some embodiments, a plurality of external gas detectors 25, could be arranged at various positions around the outside of the enclosure 2 and/or the air supply system 12 to detect gas in the surrounding air. In the embodiments illustrated and described here, the enclosure shutdown controller 20 is operable to stop the supply of electrical power 22 to the apparatus for carrying out hot work 21 when the control system 1 receives the external gas detection signal. Thus, as a precautionary measure, the apparatus for carrying out hot work 21 is shut down in the event of gas being detected outside of the enclosure 2 and the air supply system 12. However, the control system 1 is operable to maintain the supply of air 10 to the hot work enclosure 2 when the control system 1 receives an external gas detection signal from the external gas detector 25. Maintaining the supply of air 10 helps to mitigate the ingress of the external gas into the enclosure 2, as positive pressure inside the hot work enclosure 2 is maintained. However, as stated above, if gas is detected in the air supply system 12, the supply of air 10 to the enclosure 2 will be stopped.

Therefore, the control system 1 is operable to stop the supply of electrical power 22 to the apparatus for carrying out hot work 21 when the control system 1 receives a gas detection signal from the air supply gas detector 8, the external gas detector 25, and/or the enclosure gas detector 24. It will be understood that a plurality of enclosure/external/air supply gas detectors 8, 24, 25, could be used in this manner.

The control system 1 is operable to communicate with two alarm devices 26, which are operable to provide an alarm signal to a user of the hot work enclosure 2 in the event of one or more alarm conditions. In the embodiments illustrated and described here, one of the alarm devices 26 is located inside the hot work enclosure 2 and the other alarm device 26 is located outside of the hot work enclosure 2. An alarm condition could be triggered by the control system 1 receiving one or more gas detection signals, and the alarm devices 26 typically include a manual input device, which can be used to manually stop the supply of electrical power 22 to the apparatus for carrying out hot work 21.

The control system 1 is operable to control a light emitting element 27 located inside the hot work enclosure 2, and in this embodiment the light emitting element is a 24V light emitting diode connected to a back-up power supply 28, which in this embodiment is a battery.

With reference to FIG. 2, the control system 1 is operable to receive an entrance signal from an entrance point 29 of the hot work enclosure 2 when the entrance point 29 is configured in an open state. The enclosure shutdown controller 20 is operable to stop the supply of electrical power 22 to the apparatus for carrying out hot work 21 when the control system 1 receives the entrance signal, and the control system 1 is operable to apply a time-delay between receiving the entrance signal and stopping the supply of electrical power 22 to the apparatus for carrying out hot work 21. The time delay is typically approximately 10 seconds. However, the time delay could be between approximately 1 second and approximately 60 seconds. The time delay allows for the accidental opening of the entrance point 29 to be rectified without having to purge the enclosure 2. That is, if there were no time delay, then any accidental opening of the entrance point 29 would lead to an evacuation of the hot work enclosure 2 while purging took place, which would then render the hot work enclosure 2 as safe to enter. However, the control system 1 is operable to purge the hot work enclosure 2 when the control system 1 detects that the entrance point 29 has been in the open state for a period of time (typically approximately 60 seconds). If this time is reached, the hot work enclosure 2 is then deemed to be unsafe to work in, and purging of the hot work enclosure 2 takes place. The hot work enclosure 2 is then deemed safe to work in once the purging has taken placed. It should be understood that the period of time could be between approximately 1 second and approximately 120 seconds.

The control system 1 is operable to detect when the entrance point 29 to the hot work enclosure 2 is in a closed state, by receiving a unique code, or signal, from the entrance point 29 when in the closed state. The unique code, or signal, is provided from a magnetic lock. This helps to mitigate users of the hot work enclosure 2 attempting to use a method of closing the entrance point 29 using an unsafe method, as the entrance point will only provide the unique code when the entrance point 29 is safely secured. The enclosure shutdown controller 20 is operable to stop the supply of electrical power 22 to the apparatus for carrying out hot work 21 if the control system 1 detects that an entrance point 29 to the hot work enclosure 2 is not in the closed state.

The control system 1 is operable to receive an air flow rate signal from one or more air flow rate sensors 30 in the air supply system and/or inside 2b the hot work enclosure 2. The control system 1 is operable to calculate the time required to purge the hot work enclosure 2 based, at least in part, on the air flow rate signal. It should be understood that the time required to purge the hot work enclosure 2 will be approximately equivalent to the time required to render the hot work enclosure 2 safe to enter by a user of the hot work enclosure 2.

The control system 1 is operable to obtain image and/or video data from an image capture device 31 located inside the hot work enclosure 2.

The control system is operable to obtain data from one or more sensors 32 located inside the hot work enclosure 2. The sensors 32 could be configured to measure temperature, air pressure, humidity, dew point, particulate matter, and/or dust.

The further control system 1a is configured to display real time data obtained from the control system 1 to an operator, or user, of the control system 1. For example, data obtained, or associated with, the air supply shutdown module 9, the at least one air supply gas detector 8, the at least one external gas detector 25, the at least one enclosure gas detector 24, the one or more sensors 32, the one or more image capture devices 31, and/or the one or more air flow rate sensors 30 could be displayed in real time.

The further control system 1a and/or the control system 1 is operable to obtain input data from a user and to activate the air supply shutdown controller 4 to provide the air supply shutdown signal 7 to the air supply shutdown module 9 and/or to obtain input data from a user and to activate the enclosure shutdown controller 20 to stop the supply of electrical power 22 to the apparatus for carrying out hot work 21. Typically, the control system 1 and/or the further control system 1a include a user input device, such as a touch-screen interface, or the like, and/or one or more buttons, or the like. Thus, using by using the control system 1 and/or the further control system 1a, the user has control over the operation of the control system 1.

As shown in FIG. 2, the control system 1 is configured to receive electrical power from a single phase power supply 33. In the embodiment shown in FIG. 2, a power distribution module 35 is configured to receive electrical power from a three phase power supply 37 and to provide electrical power to the apparatus for carrying out hot work 21 via the enclosure shutdown controller 20.

The air supply device 12e is configured to receive electrical power from a separate, single phase supply 39. Thus, the electrical power supply can be maintained to the air supply device 12e at all times, although it will be understood that the control system 1 could be configured to shutdown the supply of electrical power to the air supply device 12e, or to shut down the operation of the air supply device 12e, in response to one or more operating conditions or events.

In the embodiments illustrated and described here, all of the electrical connection points within the hot work enclosure 2 are intrinsically safe. That is, the electrical connection points are configured to mitigate the risk of sparks when connecting/disconnecting electrical equipment to the connection points.

Modifications and improvements may be made to the foregoing embodiments without departing from the scope of the present invention. For example, at least a part of the air supply system 12 could be locatable substantially inside 2b the hot work enclosure 2. At least a part of one or more air-flow components 12a of the air supply system 12 could be located inside 2b the hot work enclosure 2.

A plurality of air supply gas detectors 8 could be locatable within the air supply system 12, and some, or all, of the air supply gas detectors 8 could be independently movable within the air supply system 12.

The control system 1 could be operable to obtain data from the at least one enclosure gas detector 24, the at least one external gas detector 25, the at least one air supply gas detector 8, the one or more sensors 32, the one or more image capture devices 31, the air supply shutdown module 9 and/or the one or more air flow rate sensors 30 using a wireless communication protocol and/or a wired connection. That is, a fully wired or wireless communication protocol, or technique could be used, or a combination of wired and wireless communication protocols.

1. A control system for use with a hot work enclosure, the control system comprising:
an air supply shutdown controller;
at least one air supply gas detector; and
an air supply shutdown module;
wherein the air supply shutdown controller is configured to receive an air supply gas detection signal from the at least one air supply gas detector in response to the presence of gas in air to be provided to the enclosure by an air supply system;
wherein the air supply shutdown controller is configured to be responsive to the air supply gas detection signal to provide an air supply shutdown signal to the air supply shutdown module to stop the supply of air to the hot work enclosure by the air supply system; and
wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module.

2. The control system of claim 1, wherein the air supply shutdown controller is operable to stop the supply of air to the hot work enclosure when the air supply shutdown controller receives an air supply gas detection signal from the at least one air supply gas detector.

3. The control system of claim 1, wherein the first position is substantially adjacent to an air inlet of the hot work enclosure.

4. The control system of claim 1, wherein the first position is substantially adjacent to an end section of at least one air-flow component of the air supply system.

5. The control system of claim 1, wherein the at least one air supply gas detector is movable within the air supply system.

6. The control system of claim 1, wherein the air supply shutdown module is movable within the air supply system.

7. The control system of claim 1, wherein the, or each, air supply gas detector is independently movable relative to the air supply shutdown module and/or wherein the air supply shutdown module is independently movable relative to the, or each, air supply gas detector.

8. The control system of claim 1, wherein the at least one air supply gas detector and/or the air supply shutdown module is detachably mountable within the air supply system.

9. The control system of claim 1, wherein the first position and the second position are between an air inlet of the air supply system and an air outlet of the air supply system.

10. The control system of claim 1, wherein an air inlet of the air supply system is proximal to the second position and distal to the first position.

11. The control system of claim 1, wherein the second position is at a predetermined air supply gas detection region of the air supply system, and the first position is at substantially the furthest possible distance from the second position within the air supply system.

12. The control system of claim 1, wherein the air supply shutdown controller, the air supply shutdown module and/or the at least one air supply gas detector is configured to be a separate, discrete component of the control system.

13. (canceled)

14. The control system of claim 1, wherein the control system is operable to detect the air flow rate of the air provided to the hot work enclosure, and wherein the control system is operable to calculate the time required to purge the hot work enclosure based, at least in part, on the air flow rate of the air provided to the hot work enclosure.

15. The control system of claim 1, wherein the air supply system comprises an air supply device, wherein the air supply device is located downstream of an air inlet of the air supply system, the at least one air supply gas detector is located downstream of the air supply device, the air supply shutdown module is located downstream of the at least one air supply gas detector and the air supply shutdown module is located upstream of the air outlet of the air supply system, relative to the air flow path of the air supply system.

16. The control system of claim 1, wherein the control system comprises an enclosure shutdown controller and wherein the enclosure shutdown controller is operable to stop the supply of electrical power to at least one apparatus for carrying out hot work when the control system receives an air supply gas detection signal from the at least one air supply gas detector.

17. (canceled)

18. The control system of claim 16, wherein the control system is operable to receive an enclosure gas detection signal from at least one enclosure gas detector in response to the presence of gas in the enclosure, and wherein the enclosure shutdown controller is operable to stop the supply of electrical power to the at least one apparatus for carrying out hot work when the control system receives the enclosure gas detection signal, and wherein the control system is operable to maintain the supply of air to the hot work enclosure when the control system receives an enclosure gas detection signal from the at least one enclosure gas detector.

19. The control system of claim 16, wherein the control system is operable to receive an external gas detection signal from at least one external gas detector in response to the presence of gas outside of the hot work enclosure and/or the air supply system, and wherein the enclosure shutdown controller is operable to stop the supply of electrical power to the at least one apparatus for carrying out hot work when the control system receives the external gas detection signal, and wherein the control system is operable to maintain the supply of air to the hot work enclosure when the control system receives an external gas detection signal from the at least one external gas detector.

20. (canceled)

21. (canceled)

22. A control system for use with a hot work enclosure, the control system comprising:
an air supply shutdown controller;
wherein the air supply shutdown controller is configured to receive an air supply gas detection signal from at least one air supply gas detector in response to the presence of gas in air to be provided to the enclosure by an air supply system;
wherein the air supply shutdown controller is configured to be responsive to the air supply gas detection signal to provide an air supply shutdown signal to an air supply shutdown module to stop the supply of air to the hot work enclosure by the air supply system; and
wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module.

23. A hot work enclosure comprising the control system of claim 22.

24. (canceled)

25. A method of controlling the supply of air to a hot work enclosure, the method comprising the steps of:
providing a control system for use with a hot work enclosure, the control system comprising:
an air supply shutdown controller;
wherein the air supply shutdown controller is arranged to receive an air supply gas detection signal from at least one air supply gas detector in response to the presence of gas in air to be provided to the enclosure by an air supply system;
wherein the air supply shutdown controller is configured to be responsive to the air supply gas detection signal to provide an air supply shutdown signal to an air supply shutdown module to stop the supply of air to the hot work enclosure by the air supply system;
wherein the air supply shutdown module is locatable at a first position in the air supply system, and the at least one air supply gas detector is locatable at a second position in the air supply system, such that, in use, the gas-contaminated air detected by the at least one gas detector is prevented from passing through the air supply shutdown module; and
using the control system to control the supply of air to the hot work enclosure.
